(19) United States
(12) Patent Application Publication
(10) Pub. No.: US 2015/0195880 A1
(43) Pub. Date: Jul. 9, 2015

(54) LIGHTING SYSTEM WITH BUILT-IN INTELLIGENCE

(71) Applicant: Lunera Lighting, Inc., Anaheim, CA (US)

(72) Inventors: Donald Barnetson, San Jose, CA (US); Junyung Wang, Palo Alto, CA (US); Daryl Cheim, San Jose, CA (US); George Xie, San Jose, CA (US)

(21) Appl. No.: 14/147,607

(22) Filed: Jan. 6, 2014

(51) Int. Cl. H05B 33/08

(52) U.S. Cl. CPC H05B 33/0845; H05B 33/0812

(57) ABSTRACT

The present invention provides an improved lighting system with built-in intelligence and a controlling unit. The controlling unit is provided with a sensor such as occupancy sensors or photo sensors as an intelligent system. The system allows the LED lamp to dim itself in response to autonomous or external stimuli. The apparatus also includes light emitting diode array and a power harvesting means for harvesting power from the LED lamp.

### FIELD OF THE INVENTION

The present application relates to an apparatus for providing intelligence to a lighting system, and more particularly, to an apparatus for providing dimming control to a lighting system.

### BACKGROUND

Over the years lighting system technology has advanced manyfold. Energy conservation in lighting systems plays a vital role in generating effective illumination, besides being cost effective. Without compromising on ambience, visual comforts and aesthetics, it is also a requisite to integrate light system-designs with economics and environment.

Of late, different light sources have come up and been replaced by improved variants. Prominent among them have been Incandescent lamps, Gas-discharge bulbs, Fluorescent Lamps and Light Emitting Diodes, to name a few. Certain factors like life-span of the light source, light distribution, light diffusion, sensitivity to temperature and humidity and operational cost are crucial in determining reliability of lighting systems.

Light emitting diodes lamps are more energy efficient as compared to other conventional source of lighting. A trend of replacing conventional lamps with the LED retrofit lamp is getting more and more popular.

Since energy conservation and management of electrical power is a growing concern with regard to both cost and environmental impact, the LED retrofit lamp technology therefore requires further improvement. Therefore a system is required that enables the user to harvest substantial portion of energy from the existing LED lamp circuit and to provide intelligent built-in features for controlling the wastage of energy.

Environment responsive intelligence in LED retrofits may further enhance energy management by drastically reducing wasteful consumption. Public spaces can be monitored on the basis of specific environmental stimuli like occupancy and time-clocks, so as to yield optimum light. This can bring significant improvement in user comfort and energy savings in commercial and industrial applications.

### BRIEF SUMMARY OF THE INVENTION

The present invention provides a controlling apparatus and method for providing intelligence to a retrofit lamp. The retrofit lamp having an array of LEDs is connected to the controlling apparatus. The controlling apparatus comprises a sensor means to monitor the required lighting parameters, a dimming control to control the brightness of the retrofit lamp in response to the parameters monitored by the sensor means, a power harvesting mean for harvesting power from the existing circuit, a micro-controller that creates a pulse width modulation in response to being asserted that in turn reduces the string length and the lamp power, a field effect transistor (FET) connected in parallel to the LED array such that the field effect transistor (FET) control the forward voltage of the retrofit lamp, a communication device to receive the instructions from the user, an external interface that receives the instruction from the sensor means or the communication device and controls the forward voltage of the retrofit lamp.

The subject invention modifies the conventional technology and saves power by introducing a dimming control that dims the light emitting diode output from 100% to 15% in response to external or internal stimuli.

The controlling apparatus has the ability to harvest a small amount of DC power from the constant current ballast to drive internal and external components. A set of series LED in the LED array is left on and the power is harvested in parallel from the set of series diode for the micro controller and the external lamp of up to 5V/100 mA. Using the field effect transistor the forward voltage of the light emitting diode array is controlled with the help of the microcontroller that creates a pulse width modulation signal at a frequency of approximately 1 KHz that enables the field effect transistor to reduce the string length and lamp power in response to overheating and external dimming signal. The sensor means receives the power harvested from the lamp and is then able to control the lamp dimming. This sensor means may be autonomous such as an occupancy or photo sensor, may be a modem allowing control at a higher level or may be a combination of sensors and a modem.

### BRIEF DESCRIPTION OF THE DRAWINGS

The preferred embodiment of the invention will hereinafter be described in conjunction with the appended drawings provided to illustrate and not to limit the scope of the invention, wherein like designation denote like element and in which:

FIG. 1 is a schematic representation of the intelligent lighting system, in accordance with an embodiment of the present invention.

FIG. 2 illustrates the component of a controlling unit with built-in intelligence feature, in accordance with an embodiment of the present invention.

FIG. 3 is a circuit diagram of an intelligence lighting system in accordance with an embodiment of the present invention.

FIG. 4 illustrates a flow diagram representing the process flow of the working of an intelligent lighting system, in accordance with an embodiment of the present invention.

### DETAILED DESCRIPTION OF THE EMBODIMENTS

In the following detailed description of embodiments of the invention, numerous specific details are set forth in order to provide a thorough understanding of the embodiment of invention. However, it will be obvious to a person skilled in the art that the embodiments of invention may be practiced with or without these specific details. In other instances well known methods, procedures and components have not been described in detail so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention provides a lighting system with built-in intelligence features to allow it to dim itself in response to autonomous or external stimuli and to harvest power for the internal and external circuit. The lighting system comprises a LED lamp driven by a ballast and a controlling unit that imparts a built-in intelligence system to the LED lamp. The circuit of the lighting system comprises a LED lamp having an array of light emitting diodes, wherein one set of the series diodes is left on and the power is harvested, in parallel from the set of series diode. A field effect transistor (FET) is wired in parallel with a portion of the light emitting diode array; the field effect transistor controls the forward voltage of the LED lamp. The Field Effect Transistor, when turned off, exposes the full light emitting diode array and the maximum forward voltage to the LED lamp. Similarly field effect transistor, when turned on, short circuits many of the light emitting diodes and reduces the forward voltage and the power drawn from the ballast.

The embodiments of the present invention comprise a controlling apparatus with an 8 bit micro controller, a power conditioning circuitry such as a Low Dropout Regulator (LDO) to regulate power to the peripheral interface controller (Microcontroller unit) and an external interface.

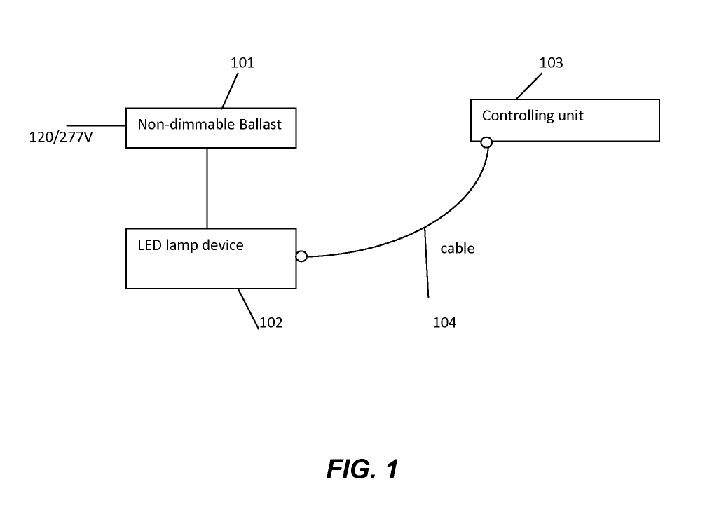

FIG. 1 is a schematic representation of the intelligent lighting system, in accordance with an embodiment of the present invention. The lighting system comprises a non-dimmable ballast 101, a LED lamp 102 and a controlling unit 103 with built-in intelligence features. The non-dimmable ballast 101 regulates the current to the LED lamp 102 and provides sufficient voltage to start the LED lamp 102. At the start-up of the LED lamp 102, the non-dimmable ballast 101 supplies high voltage to establish an arc. Once the arc is established, the non-dimmable ballast 101 quickly reduces the voltage and regulates the electric current to produce a steady light output. The controlling unit 103 receives power from the LED lamp 102 through a micro USB cable 104 and harvests the power to drive the circuitry of the controlling unit 103 and small power driven devices or sensors connected to the controlling unit 103. The power is harvested in range of 5V/100 mA sufficient to drive the circuit electronics of the controlling unit 103.

In an embodiment of the invention, the controlling unit 103 may enable additional functionality to the LED lamp 102 such as power reduction for thermal management, top trimming at factory via the controlling unit 103, and top trimming in field via circuit switching or other stimulus. Furthermore, a single controlling unit 103 can control a plurality of LED lamps 102. The lamp may be circuit switched via the controlling unit 103, in addition to being locally controlled. The controlling unit 103 further comprises a means for sensing the ambient parameters such as an occupancy sensor or a photo sensor. The controlling unit 103 further comprises a modem that allows control at a higher level or may comprise of a combination of the sensors and the modem.

The controlling unit 103 is further connected to an external monitoring device such as an occupancy sensor or a photo sensor. The controlling unit 103 receives the input from the monitoring device and controls the dimming of the LED lamp 102. The occupancy sensor is a lighting control device that detects occupancy of a space by people and turns the lights on or off automatically, using infrared or ultrasonic technology. The energy saved by the occupancy sensors provides automatic control over lighting and complies with the building's codes.

In an embodiment of the present invention the controlling unit 103 harvests a small amount of DC power from the constant current supplied by the non-dimmable ballast 101. The harvested power is then used to drive the external and internal electronics of the controlling unit 103 as well as the monitoring device. Thus there is no need of providing extra power to the controlling unit 103.

In another aspect of the present invention, the controlling unit 103 further comprises a means to control the forward voltage to the LED lamp 102 that enables the dimming of LED lamp 102 in response to external stimuli.

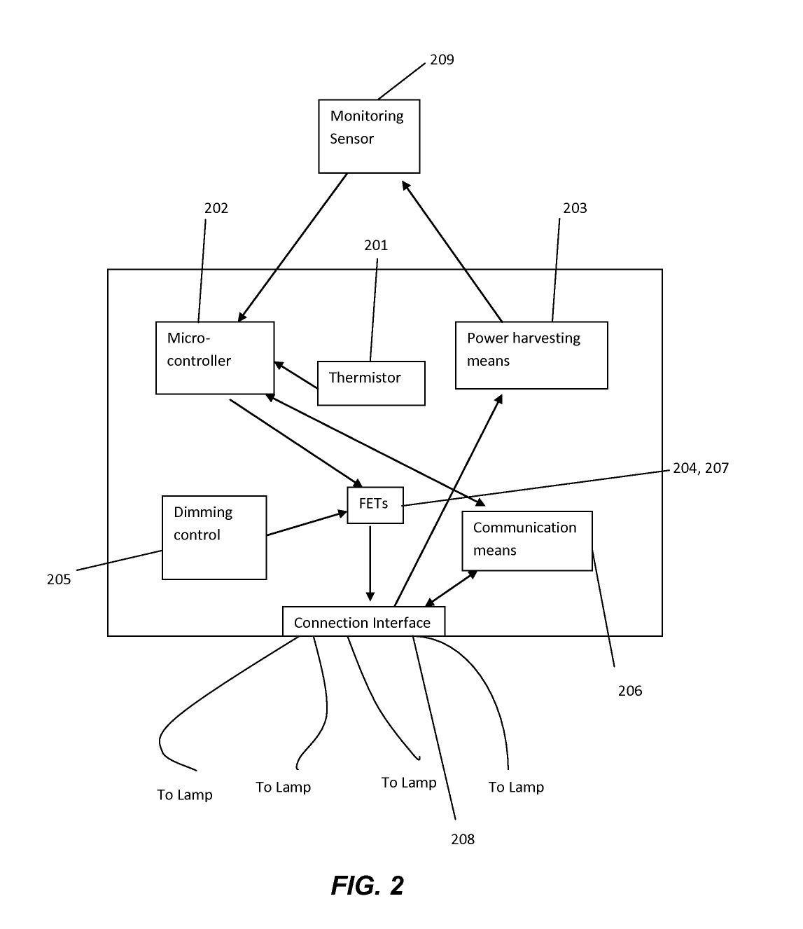

FIG. 2 illustrates the component of a controlling unit 103 with built-in intelligence feature, in accordance with an embodiment of the present invention. The controlling unit 103 comprises of a thermistor 201 that serves as a temperature sensing input, an 8 bit micro controller 202, a field effect transistors 204 and 207, a power harvesting means 203, a dimming control means 205, a communication means 206, a connection interface 208, a monitoring sensor 209 to sense the lighting parameters. The monitoring sensor 209 collects the ambient information and calculates the required light intensity in the monitored area and feed its input to the micro-controller 202 in the controlling unit 103. The controlling unit 103 is connected to a plurality of the LED lamp 102 through a USB interface 208. The wiring required for connection is class-2 type, thus eliminating the need of a skilled person. A cable 104 is required for transferring information to and fro form the controlling unit 103 to the LED lamp 102 and also provides a mean for transferring power from one of the LED arrays 308 in the LED lamp 102 to the controlling unit 103.

The controlling unit 103 contains a power harvesting means 203 that harvest the power simultaneously from the LED lamp 102. The LED lamp 102 contains a series of LED array 308 that always remains in an ON position; a circuit is extended parallel from the LED strings from where power is drawn to the power harvesting means 203 in the controlling unit 103 using the micro USB cable 104 and the connection interface 208. The power harvesting means 203 in the controlling unit 103 stores the power and uses it for driving the internal components of the controlling unit 103 as well as for feeding power to the monitoring sensors 209. The use of power harvesting means 203 eliminates the need of extra source of power for driving the controlling unit 103.

In an embodiment of the present invention, the connection interface 208 is connected to the LED lamp 102 through the cable 104 which is class 2 type. The cable 104 comprises a micro USB cable, RJ11, RJ14, RJ21, RJ45, RJ48 or other known class 2 type cables.

The Field Effect Transistors 204 and 207 present in the controlling unit 103 control the forward voltage to the LED lamp 102. The field effect transistors 204 and 207 are circuited in parallel with the portion of LED array 308. Turning the field effect transistors 204 and 207 off exposes the full LED array 308 and thus maximum forward voltage to the LED lamp 102. On turning the field effect transistors 204 and 207 ON, many of the LEDs get short circuits thereby reducing the forward voltage and power drawn from non-dimmable ballast 101.

The dimming control 205 in the controlling unit 103 controls the illumination intensity of LED lamp 102. The microcontroller 202 receives the input from monitoring sensors 209 and on receiving the input instructs the dimming control 205 to control the output to the LED lamp 102. The dimming control 205 then sends instruction to the field effect transistors 204 and 207 to reduce the forward voltage to LED lamp 102.

In another embodiment of the present invention, the forward voltage to the LED lamp 102 is controlled by placing a series of FET connected in parallel to the LED array. On receiving an input from the dimming control 205, the microcontroller 202 decides the number of FETs to remain in ON position. Each FET in the series is having an extra LED connected to the series. Depending on the instructions received from the microcontroller 202, the FETs in series turn ON additional LEDs thus regulating the forward voltage to the LED lamp 102.

In an embodiment of the present invention, the lighting system further comprises a thermistor 201 that monitors the temperature of the LED lamp circuit 102. The thermistor 201 may be present in the LED lamp 102 or it may be in the controlling unit 103. In case of overheating, the thermistor 201 senses the temperature and sends the feedback to the microcontroller 202. The microcontroller 202 then instructs the field effect transistors 204 and 207 to regulate the forward voltage in the event of the overheating of circuit.

In another embodiment of the present invention the controlling unit 103 further comprises a communication means 206 such as a modem or a radio frequency means. The communication means 206 is connected to the microcontroller 202. The user can send his instructions to the microcontroller 202 using the communication means 206.

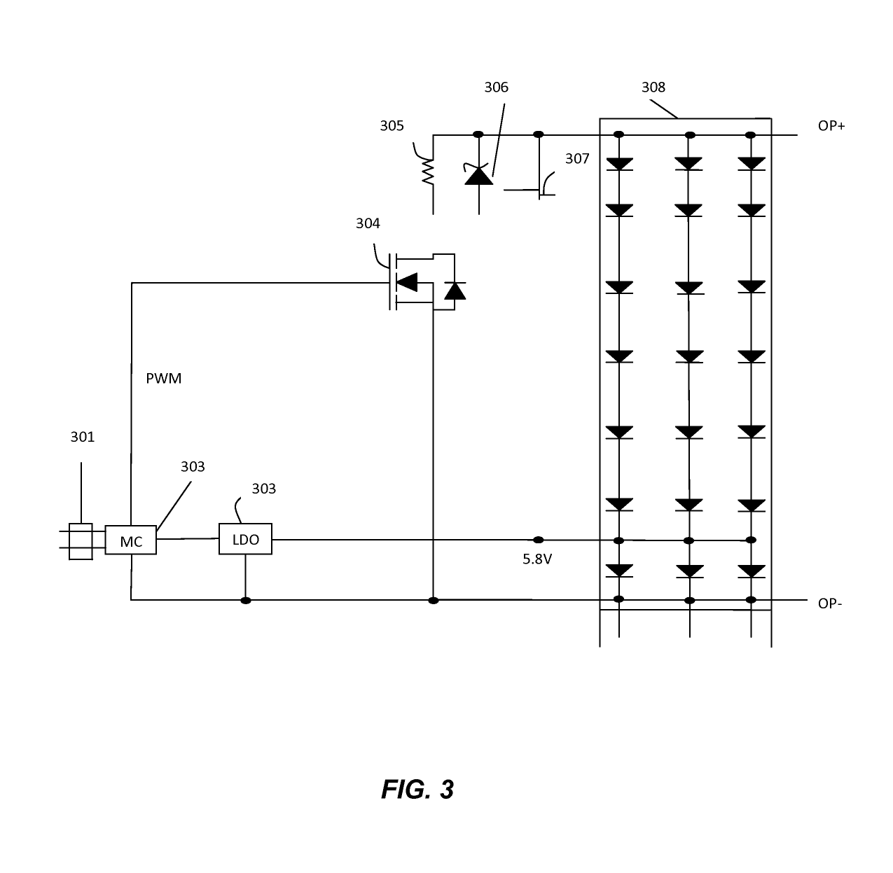

FIG. 3 is a circuit diagram of a controlling unit 103 in accordance with an embodiment of the present invention. Referring to FIG. 3, the schematic arrangement of the controlling unit 103 shows that the inputs in the form of temperature sensing input from the thermistor 201 and dimming control input from the monitoring sensors 209 are being fed to the microcontroller 202 that creates a pulse width modulated signal at a frequency of approximately 1 kHz to field effect transistors 204 and 207 that reduces the string length and lamp power in response to being asserted. The thermistor 201 serves the purpose of sending an input to the microcontroller 202 that enables the field effect transistors 204 and 207 to reduce power level in response to overheating and an external dimming signal. A low dropout regulator 303 functions as a power conditioning circuitry to regulate power to the monitoring sensor 209, the controlling unit 103 and the LED lamp 102. The low dropout regulator 303 operates with a very small input-output differential voltage and includes a lower minimum operating voltage, higher efficiency operation and lower heat dissipation. The Zener diode 306 allows current to flow in the forward direction and also permits current to flow in the reverse direction when the voltage is above a certain value. The field effect transistors 204 and 207 have the ability to control the forward voltage of the LED lamp 102 that is wired in parallel with a portion of the LED array 308. When the field effect transistors 204 and 207 are turned OFF, it exposes the full LED array 308 and the maximum forward voltage to the ballast and turning the field effect transistors 204 and 207 ON short circuits many of the light emitting diodes, which reduces the forward voltage and the power drawn from the ballast. The light emitting diode array 308 is left ON and power is harvested in parallel from the array for the internal microcontroller 202 and an external lamp of up to 5V/100 mA.

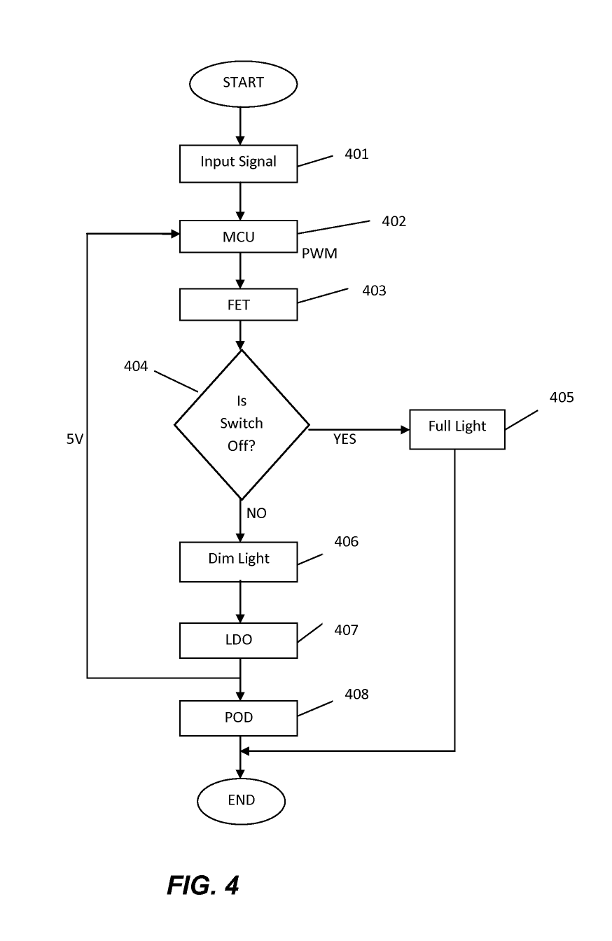

FIG. 4 illustrates a flow diagram representing the working of the lamp circuit in accordance with an embodiment of the present invention. In step 401 when an input signal is fed to the microcontroller unit 202 from the thermistor 201, a pulse width modulated signal is generated in step 402. The pulse width modulated signal generated in step 402 is then relayed to the field effect transistors 204 and 207 in step 403. It will further check in step 404 whether the field effect transistors 204 and 207 are switched ON or switched OFF. When the field effect transistors 204 and 207 are switched OFF, it exposes the full light emitting diode array 308 and the maximum forward voltage to the non-dimmable ballast 101 as shown in step 405. When the field effect transistors 204 and 207 are turned ON, it short circuits many of the light emitting diodes present in the light emitting diode array 308 and reduces the forward voltage and the power drawn from the non-dimmable ballast 101 in step 406. The dimmed light is then relayed to the low dropout regulator 303. The low dropout regulator 303 regulates the power to a peripheral interface controller and external interface for microcontroller 202 in step 407 and LED lamp 102 in step 408. Hence, the lighting system has sufficient built in intelligence to allow it to dim itself in response to autonomous or external stimuli.

The invention finds lightening application in various areas like indoor light, outdoor light and various other decoration or ornamental light, power reduction for thermal management. The lighting system has ability to harvest a small amount of DC power from the constant current AC ballast to drive internal and external electronics.

We claim:

1. A lighting system with built-in intelligence comprising:
(a) a LED lamp with a plurality of LEDs arranged in multiple rows with each row having a series of LED arrays;
(b) a plurality of monitoring sensors that monitor ambient lighting conditions, are in communication with a controlling unit, and transmit instructions to the controlling unit;
(c) said controlling unit having a microcontroller that receives instructions from the plurality of monitoring sensors and controls the forward voltage to the LED lamp on receiving said instructions, said microcontroller harvesting power from the circuit of the LED lamp;
wherein the controlling unit can be connected to a plurality of the LED lamps through a cable.

2. The lighting system of claim 1 wherein the LED lamp is driven from an external AC non dimmable ballast.

3. The lighting system of claim 1 wherein the plurality of monitoring sensor comprises occupancy sensor, photo sensors.

4. The lighting system of claim 1 wherein the controlling unit harvest power from the LED lamp.

5. The lighting system of claim 1 wherein the cable used to connect the controlling unit with the LED lamp comprises a micro USB cable, RJ11, RJ14, RJ21, RJ45, RJ48 or a class 2 cable.

6. The lighting system of claim 1 wherein the microcontroller is 8 bit, 16 bit, 32 bit or 64 bit.

7. The lighting system of claim 1 wherein the harvested power is used for driving the circuit of the controlling unit and the plurality of monitoring sensor.

8. The lighting system of claim 1 wherein the forward voltage is controlled by a field effect transistor

9. The lighting system of claim 8 wherein the field effect transistor is circuited in parallel to the LED array.

10. The lighting system of claim 1 wherein the microcontroller creates a pulse width modulation signal to the FET which reduces the string length and lamp power in response to being asserted.

11. The lighting system of claim 1 wherein the microcontroller controls the forward voltage switching a series of FETs that reduce the string length and lamp power in response to being asserted.

12. The lighting system of claim 1 wherein the microcontroller receives inputs from a thermistor lamp on the event of overheating or a short-circuit.

13. A controlling unit that imparts intelligence features to a LED lamp comprising:
(a) a power harvesting unit placed parallel to a series of LED arrays for harvesting power from the series of LED arrays;
(b) one or more field effect transistors placed in parallel with a portion of LED array that controls the forward voltage to the LED lamp;
(c) a plurality of monitoring sensors which monitor lighting parameters;
(d) a thermistor to detect the temperature of the controlling unit and the LED lamp;
(e) a microcontroller unit in communication with the one or more field effect transistors, the thermistor and the plurality of monitoring sensors; said microcontroller instructing the one or more field effect transistors to control the forward voltage upon receiving input from the thermistor and the plurality of monitoring sensors.

14. The controlling unit of claim 13 wherein the controlling unit allows the LED lamp to dim itself in response to the external and internal stimuli.

15. The controlling unit of claim 14 wherein the external stimuli comprises the input from the plurality of monitoring sensors.

16. The controlling unit of claim 14 wherein the internal stimuli comprises the input from thermistor on the event of overheating or a short-circuit.

17. The controlling unit of claim 15 wherein the microcontroller on receiving the instructions from thermistor and plurality of monitoring sensors regulate the forward voltage to the LED lamp by turning on the field effect transistor.

18. The controlling unit of claim 13 wherein the field effect transistor(s) when turned off exposes the maximum forward voltage to the LED lamp and turning on the FET short circuit many of the LEDs reducing the forward voltage.

19. The controlling unit of claim 13 wherein the harvested power is utilized to drive the electronics of the controlling unit and the plurality of monitoring sensors.

20. The controlling unit of claim 13 wherein the plurality of monitoring sensors comprises occupancy sensor or photo sensor.

21. The controlling unit of claim 12 wherein the microcontroller receives instructions from a higher level control system via a modem.
